(19) United States
(12) Patent Application Publication
(10) Pub. No.: US 2019/0356648 A1
(43) Pub. Date: Nov. 21, 2019

(54) RESOURCE EXTENSION METHOD AND DEVICE FOR A ZONE OF A CLOUD SERVICE PLATFORM, APPARATUS AND COMPUTER-READABLE STORAGE MEDIUM

(71) Applicant: Ping An Technology (Shenzhen) Co., Ltd., Shenzhen, Guangdong (CN)

(72) Inventor: Bo Feng, Shenzhen, Guangdong (CN)

(21) Appl. No.: 16/097,615

(22) PCT Filed: Feb. 2, 2018
(86) PCT No.: PCT/CN2018/075116

§ 371 Date: Oct. 29, 2018

(30) Foreign Application Priority Data
Sep. 25, 2017 (CN) 201710875182.0

(51) Int. Cl. H04L 29/06; H04L 12/24; H04L 29/08

(52) U.S. Cl. CPC H04L 63/0815; H04L 63/0869; H04L 67/10; H04L 41/0813; H04L 41/0893

(57) ABSTRACT

The embodiments of the present application provide a resource extension method and device for a zone of a cloud service platform, an apparatus and a computer-readable storage medium. The method includes: pre-processing a cloud service platform; verifying a first virtual environment management platform in a zone of the cloud service platform by a single sign-on service; adding a cluster in a second virtual environment management platform to the zone of the cloud service platform by the single sign-on service, to complete resource extension for the zone of the cloud service platform. The embodiments of the present application could extend the zone resource of the cloud service platform, and could fully utilize the network of the zone, and don't need to modify the network segment of the tenant after extending the zone resource.

The present application claims the priority to the Chinese patent application No. CN201710875182.0, filed with the Chinese Patent Office on Sep. 25, 2017 and entitled “resource extension method and device for a zone of a cloud service platform, an apparatus and a computer-readable storage medium”, the contents of which are incorporated herein by reference in its entirety.

### FIELD OF INVENTION

The present disclosure relates to the technical field of information processing, and more particularly, to a resource extension method and device for a zone of a cloud service platform, an apparatus and a computer-readable storage medium.

### BACKGROUND OF INVENTION

CloudStack is an open source, highly available and scalable cloud computing platform, meanwhile, CloudStack is an open source cloud computing solution that could accelerate the deployment, management and configuration of highly scalable public and private clouds. The following will call CloudStack as a cloud service platform. A zone is a data center of a cloud service platform, which could manage one or more providing points. The providing point refers to a Pod in the CloudStack. Each providing point corresponds to a virtual environment management platform, and multiple providing points could share a virtual environment management platform. Wherein, the virtual environment management platform refers to a vCenter, and the vCenter refers to a VMware vCenter Server, which could centrally manage the VMware vSphere environment and improve the control to the virtual environment. Currently, one single zone (zone) of a cloud service platform could only manage one virtual environment management platform (vCenter), and one network only belongs to one single zone. This has the following problems: the size of a single zone is limited by the management capability of the virtual environment management platform, and the number of the cloud hosts managed by the virtual environment management platform could not exceed a preset number, such as 10,000. If the number of the cloud hosts managed by the virtual environment management platform exceeds an upper limit, a new zone is needed, and the network segment of the new zone cannot continue to use the network segment of the original zone, and the tenant cannot continue to use the network segment of the original zone, and the network segment used by the tenant needs to be re-established. As a result, the network of the original zone is not fully utilized; on the other hand, the change for the tenant to modify the network segment is too much.

### SUMMARY OF THE INVENTION

The embodiments of the present disclosure provide a resource extension method and device for a zone of a cloud service platform, an apparatus and a computer-readable storage medium, which could extend the zone resource of the cloud service platform, and could fully utilize the network of the zone and don't need to modify the network segment of the tenant after extending the zone resource.

In a first aspect, the embodiments of the present disclosure provide a resource extension method for a zone of a cloud service platform, comprising: pre-processing a cloud service platform; verifying a first virtual environment management platform in a zone of the cloud service platform by a single sign-on service; and adding a cluster in a second virtual environment management platform to the zone of the cloud service platform by the single sign-on service, to complete resource extension for the zone of the cloud service platform, if an instruction of adding the second virtual environment management to the zone of the cloud service platform is received.

In a second aspect, the embodiments of the present disclosure provide a resource extension device for a zone of a cloud service platform, and the device comprises a unit for performing the resource extension method for a zone of a cloud service platform according to the above first aspect.

In a third aspect, the embodiments of the present disclosure further provide an apparatus, and the apparatus comprises a memory, and a processor connected to the memory; the memory is used for storing program data for implementing resource extension for a zone of a cloud service platform; the processor is used for running the program data stored in the memory, to perform the resource extension method for a zone of a cloud service platform according to the above first aspect.

In a fourth aspect, the embodiments of the present disclosure provide a computer-readable storage medium, and the computer-readable storage medium stores one or more program data which could be executed by one or more processors, to implement the resource extension method for a zone of a cloud service platform according to the above first aspect.

The embodiments of the present disclosure, pre-processing a cloud service platform; verifying a first virtual environment management platform in a zone of the cloud service platform by a single sign-on service; adding a cluster in a second virtual environment management platform to the zone of the cloud service platform by the single sign-on service, to complete resource extension for the zone of the cloud service platform, if an instruction of adding the second virtual environment management to the zone of the cloud service platform is received. The embodiments of the present disclosure could extend the zone resource of the cloud service platform, and could fully utilize the network of the zone, and don't need to modify the network segment of the tenant after extending the zone resource.

### BRIEF DESCRIPTION OF THE DRAWINGS

FIG. 1 is a structure schematic diagram of a cloud service platform provided by an embodiment of the present disclosure;

FIG. 2 is a flow chart of a resource extension method for a zone of a cloud service platform provided by an embodiment of the present disclosure;

FIG. 3 is a sub-flow chart of a resource extension method for a zone of a cloud service platform provided by an embodiment of the present disclosure;

FIG. 4 is a sub-flow chart of FIG. 3 provided by an embodiment of the present disclosure;

FIG. 5 is a sub-flow chart of FIG. 3 provided by another embodiment of the present disclosure;

FIG. 6 is a sub-flow chart of FIG. 5 provided by an embodiment of the present disclosure;

FIG. 7 is a structure schematic diagram of a cloud service platform provided by another embodiment of the present disclosure;

FIG. 8 is a schematic block diagram of a resource extension device for a zone of a cloud service platform provided by an embodiment of the present disclosure;

FIG. 9 is a schematic block diagram of an extension unit provided by an embodiment of the present disclosure;

FIG. 10 is a schematic block diagram of an adding unit provided by an embodiment of the present disclosure;

FIG. 11 is a schematic block diagram of a zone extension unit provided by an embodiment of the present disclosure;

FIG. 12 is a schematic block diagram of a cluster extension unit provided by an embodiment of the present disclosure; and

FIG. 13 is a schematic block diagram of a resource extension apparatus for a zone of a cloud service platform provided by an embodiment of the present disclosure.

### DESCRIPTION OF THE EMBODIMENTS

Unless otherwise stated, a cloud service platform involved in the description of the following embodiments refers to CloudStack, and a zone refers to the Zone in CloudStack.

FIG. 1 is a structure schematic diagram of a cloud service platform provided by an embodiment of the present disclosure. The structure schematic diagram of the cloud service platform shown in FIG. 1 is a structure schematic diagram of an existing cloud service platform. As shown in FIG. 1, a cloud service platform has multiple zones, such as zone Zone01 and zone Zone02. One zone manages a virtual environment management platform, for example, the zone Zone01 manages a first virtual environment management platform vCenter01, and the zone Zone02 manages a second virtual environment management platform vCenter02. A zone comprises a plurality of providing points, such as the zone Zone 01 comprises a providing point Pod01. A providing point comprises multiple clusters, for example, the providing point Pod01 comprises cluster Cluster01, cluster Cluster02, and cluster Cluster03. Each cluster has multiple hosts, for example, the cluster Cluster01 comprises a host Host01, a host Host02, a host Host03, and a host Host04. Each host could run multiple virtual machines, for example, the host Host01 runs a virtual machine ECS01, a virtual machine ECS02, and a virtual machine ECS03. Wherein, a zone is generally regarded as a separate data center, and the designed structure characteristics of the zone are used to provide isolation and redundancy. For example, each zone could have its own independent power supply and network connections, and each zone could be separated by different physical locations. In the same data center, different providing points mean different basic facilities, such as different hosts, different network devices, and different power supply devices. A providing point comprises multiple clusters, and generally, a cluster comprises multiple hosts. Hosts in the same cluster have the same hardware, and share the same storage, and so on. In the cloud service platform, one single zone could only manage one virtual environment management platform, and one network could only belong to one single zone. For example, the network Network01 only belongs to the zone Zone01, and the network Network02 only belongs to the zone Zone02.

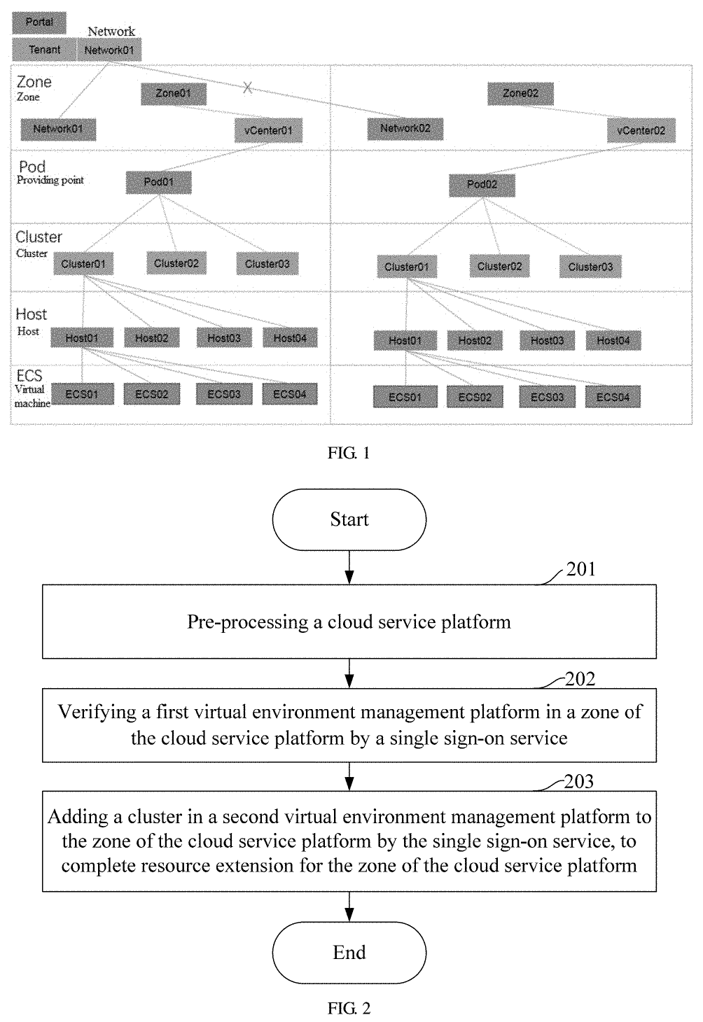

FIG. 2 is a flow chart of a resource extension method for a zone of a cloud service platform provided by an embodiment of the present disclosure. The method is applied to a server of a cloud service platform. As shown in FIG. 2, the method comprises the following steps S201-S203.

S201, pre-processing a cloud service platform. Because in a cloud service platform, one single zone could only manage one virtual environment management platform. Therefore, when adding a new resource such as a host to a zone, it needs to determine whether the host to be added belongs the hosts in the virtual environment management platform managed by the zone. Pre-processing the cloud service platform could be understood as modifying the judgment logic, so when adding a host to the zone, it doesn't need to determine whether the host to be added belongs to the hosts in the virtual environment management platform managed by the zone. Wherein, a virtual environment management platform comprises multiple clusters, and each cluster comprises multiple hosts.

S202, verifying a first virtual environment management platform in a zone of the cloud service platform by a single sign-on service.

The zone here may be any one of a plurality of zones of the cloud service platform. The first virtual environment management platform is a virtual environment management platform managed by the zone. The virtual environment management platform vCenter has integrated the single sign-on service since the version vCenter 5.5, and it could be understood that the single sign-on service has been added to the versions after the version vCenter 5.5. Wherein, the single sign-on service refers to the SSO (Single Sign On) service; and in a single sign-on to multiple application systems, user could access all trusted application systems, only needing to log in once. The first virtual environment management platform in the zone of the cloud service platform is verified by the single sign-on service, comprising: enabling a single sign-on service of the first virtual environment management platform, and adding a domain name and a IP address of the first virtual environment management platform and a username and a password for the single sign-on service in the single sign-on service. For example, when installing the first virtual environment management platform, choose to enable the self-contained single sign-on service, such as choosing the “embedded deployment” single sign-on service, and add the domain name and the IP address of the first virtual environment management platform, and add a username and a password for the single sign-on service. In the cloud service platform, the specific process of the single sign-on is as follows: the cloud service platform logs into the first virtual environment management platform by using the username and the password, and the authentication center of the single sign-on service performs identity verification according to the provided username and password information, and if being verified, a authenticated credential, that's a token (ticket), is generated; when the user accesses the second virtual environment management platform, the token is taken, to be a credential for self-verification, and after receiving the request, the second virtual environment management platform sends the token to the authentication center of the single sign-on service for verification, checking the validity of the token. If being verified, the user could access the second virtual environment management platform without logging into again.

In other embodiments, if the performance of the single sign-on service self-contained in the first virtual environment management platform is insufficient, or for other reasons, not to use the single sign-on service self-contained in the first virtual environment management platform. In this case, one or more single sign-on servers could be added to provide a single sign-on service, so as to perform unified management.

S203, adding a cluster in a second virtual environment management platform to the zone of the cloud service platform by the single sign-on service, to complete resource extension for the zone of the cloud service platform.

If the second virtual environment management platform does not exist, create the second virtual environment management platform, and add the second virtual environment management platform by the single sign-on service, that is, add the domain name and the IP address of the second virtual environment management platform by the single sign-on service, to complete mutual verification between the single sign-on service and the second virtual environment management platform. After completing the verification, the cluster in the second virtual environment management platform could be added to the cloud service platform according to actual needs, to complete the resource extension for the zone of the cloud platform. It should be noted that, after creating the second virtual environment management platform, the second virtual environment management platform needs to be added clusters, and the cluster needs to be added hosts.

The above embodiment could extend the zone resource of the cloud service platform, and could fully utilize the network of the zone, and does not need to modify the network segment of the tenant after extending the zone resource.

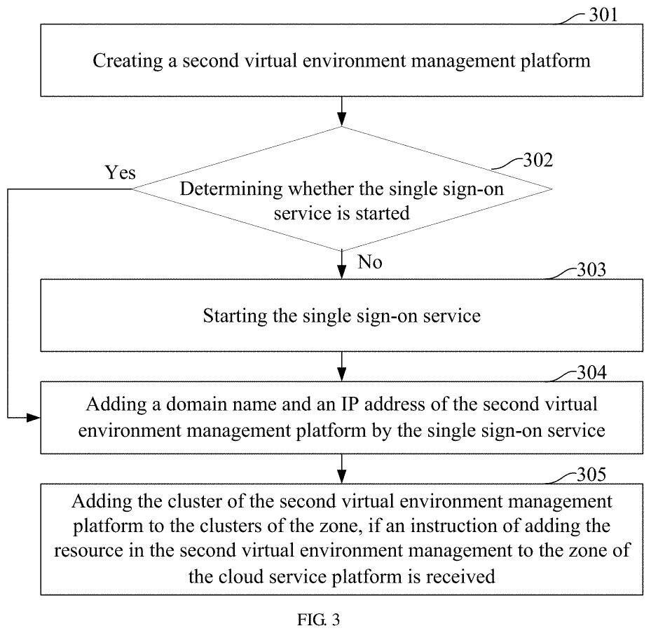

Specifically, as shown in FIG. 3, adding a cluster in a second virtual environment management platform to the zone of the cloud service platform by the single sign-on service, that is, the step S203 comprises S301-S305.

S301, creating a second virtual environment management platform.

It can be understood that, in the cloud service platform, one zone could only manage one virtual environment management platform, so the second virtual environment management platform does not exist. If one wants to add a second virtual environment management platform to the zone of the cloud service platform, one needs to create a second virtual environment management platform. The specific method for creating the second virtual environment management platform is: download the VMware vCenter Server installation package, and after downloading, click the installation button to install and deploy according to the flow.

S302, determining whether the single sign-on service is started.

The single sign-on service here refers to the single sign-on service that is verified by the first virtual environment management platform. Specifically, if the single sign-on service verified by the first virtual environment management platform is its own single sign-on service, the single sign-on service in this step refers to the single sign-on service of the first virtual environment management platform itself; if the single sign-on service verified by the first virtual environment management platform is an external single sign-on server, the single sign-on service in this step refers to the external single sign-on server.

S303, starting the single sign-on service if the single sign-on service is not started. Wherein, the sequence of steps S302-S303 and step S301 is not limited.

S304, adding a domain name and an IP address of the second virtual environment management platform by the single sign-on service if the single sign-on service is started.

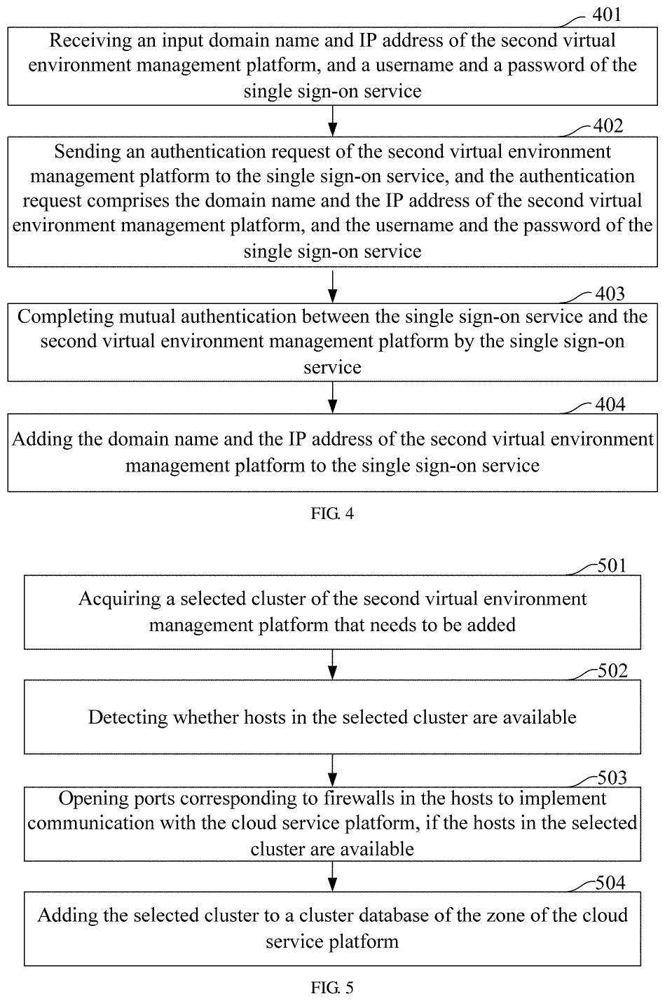

Specifically, as shown in FIG. 4, adding a domain name and an IP address of the second virtual environment management platform by the single sign-on service, that is, step S304 comprises S401-S404.

S401, receiving an input domain name and IP address of the second virtual environment management platform, and a username and a password of the single sign-on service. In the installation and deployment of VMware vCenter Server, when deploying the single sign-on service, disable its own single sign-on service, and choose to join the external single sign-on service, and the external single sign-on service here refers to the single sign-on service verified by the first virtual environmental management platform. For example, disable “Embedded Deployment”, choose “External Deployment”; on an interface corresponding to “External Deployment”, enter the domain name and the IP address of the second virtual environment management platform, and log in the username and the password of the single sign-on service, and the port number of the single sign-on service, such as port number 443.

S402, sending an authentication request of the second virtual environment management platform to the single sign-on service, and the authentication request comprises the domain name and the IP address of the second virtual environment management platform, and the username and the password of the single sign-on service. Wherein, the username and the password of the single sign-on service refer to the username and the password for logging into the single sign-on service. The authentication request also comprises the port number of the single sign-on service.

S403, completing mutual authentication between the single sign-on service and the second virtual environment management platform by the single sign-on service. After receiving the authentication request of the second virtual environment management platform, the single sign-on service determines whether the domain name and the IP address in the authentication request match; if yes, save the certificate information sent by the second virtual environment management platform in the single sign-on service; sent the certificate information of the single sign-on service to the second virtual environment management platform to complete the mutual authentication between the single sign-on service and the second virtual environment management platform.

S404, adding the domain name and the IP address of the second virtual environment management platform to the single sign-on service. In this way, adding the second virtual environment management platform which uses the single sign-on service to the zone is completed. The first virtual environment management platform and the second virtual environment management platform in the zone use the single sign-on authentication method, and all use the single sign-on service to log in. The first virtual environment management platform and the second virtual environment management platform in the zone use the single sign-on authentication method, so the zone could break through the limitation that a single zone of the cloud service platform could only manage one vCenter.

S305, adding the cluster of the second virtual environment management platform to the clusters of the zone, if an instruction of adding the resource in the second virtual environment management to the zone of the cloud service platform is received.

When the resource in the second virtual environment management platform needs to be added to the cloud service platform, click the button for adding resource on the user operation interface of the cloud service platform, to generate an instruction of adding the resource of the second virtual environment management platform to the zone of the cloud service platform. If the instruction of adding the resource in the second virtual environment management is received, add the cluster of the second virtual environment management platform to the clusters of the zone, to complete the resource extension for the zone of the cloud service platform.

Specifically, as shown in FIG. 5, adding the cluster of the second virtual environment management platform to the clusters of the zone, that is, step S305 comprises S501-S504.

S501, acquiring a selected cluster of the second virtual environment management platform that needs to be added. Wherein, there may be multiple clusters in the second virtual environment management platform, and select the cluster that needs to be added. When adding the cluster, enter the domain name or the IP address of the second virtual environment management platform, to improve the security of data access. Since the second virtual environment management platform has verified by the single sign-on service, if the user has logged into the first virtual environment management platform, the second virtual environment management platform could be accessed without logging in now.

S502, detecting whether hosts in the selected cluster are available. For example, detect whether the hosts in the selected cluster could not start up, or whether the network has a problem, and the like.

S503, opening ports corresponding to firewalls in the hosts to implement communication with the cloud service platform, if the hosts in the selected cluster are available.

S504, adding the selected cluster to a cluster database of the zone of the cloud service platform. It should be noted that, take a cluster as a unit to add, instead of adding host one by one. The addition taking a cluster as a unit could be easily managed and the efficiency of the addition is high.

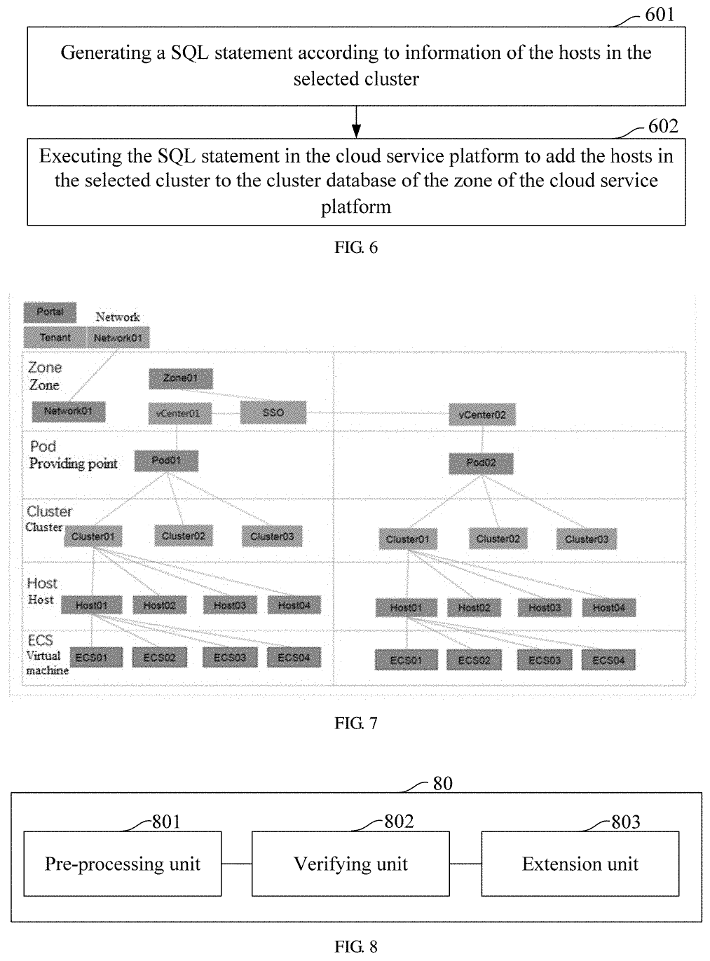

Specifically, as shown in FIG. 6, S504 comprises S601-S602.

S601, generating a SQL statement according to information of the hosts in the selected cluster. For example, the SQL statement for inserting, insert into the table name (column 1, column 2 . . . ) VALUES (value 1, value 2 . . . ), or other SQL statements, such as SQL statement for stored procedure.

S602, executing the SQL statement in the cloud service platform to add the hosts in the selected cluster to the cluster database of the zone of the cloud service platform. In this way, adding the cluster of the second virtual environment management platform to the cluster of the zone is completed, realizing the resource extension for the zone of the cloud service platform.

After adding the hosts in the selected cluster to the cluster database of the zone of the cloud service platform, the hosts in the selected cluster have become the hosts of the cluster of the zone of the cloud service platform. In order to facilitate unified management and improve management efficiency, modify the name of the hosts in the newly added cluster according to a preset rule. Wherein, the preset rule is determined by a naming rule of the zone of the specific cloud service platform. For example, the added hosts use Tag management method, for example, add Tag VC01 before the name of the hosts in vCenter0l, and add Tag VC02 before the name of the hosts in vCenter02.

FIG. 7 is a structure schematic diagram of a cloud service platform provided by another embodiment of the present disclosure. FIG. 7 is a structure schematic diagram of a cloud service platform after being added a cluster in the second virtual environment management platform. As shown in FIG. 7, a single zone of the cloud service platform comprises a first virtual environment management platform, and also comprises a second virtual environment management platform, for example, the zone Zone 01 comprises a first virtual environment management platform vCenter0l and a second virtual environment management platform vCenter02, and both of the vCenter0l, and vCenter02 use the single sign-on service in the vCenter0l to verify. This breaks through the limitation that a single zone of the cloud service platform could only manage one vCenter, and realizes the resource extension for the zone of the cloud service platform. After the resource of the zone is extended, a network Network01 could provide service for the vCenter01, and could also provide service for the vCenter02. That is, both of vCenter01 and vCenter02 could use the network of the zone, without establishing a network Network02. The zone could still use the network segment of the original zone, and the upper layer tenant does not need to re-establish a network segment.

The above embodiment uses the single sign-on authentication method by the vCenter, and on the premise that the first virtual environment management platform uses the single sign-on authentication in the zone of the cloud service platform, the second virtual environment management platform using the same single sign-on service is added, breaking through the limitation that a single zone of the cloud service platform could only manage one vCenter, and realizing the resource extension for the zone of the cloud service platform, and after the resource extension, the upper layer tenant could still use the network segment of the original zone, and the upper layer tenant does not need to re-establish a network segment.

FIG. 8 is a schematic block diagram of a resource extension device for a zone of a cloud service platform provided by an embodiment of the present disclosure. The device is applied to a server of a cloud service platform. The device 80 comprises a pre-processing unit 801, a verifying unit 802, and an extension unit 803.

The pre-processing unit 801 is used for pre-processing a cloud service platform. The verifying unit 802 is used for verifying a first virtual environment management platform in a zone of the cloud service platform by a single sign-on service. The extension unit 803 is used for adding a cluster in a second virtual environment management platform to the zone of the cloud service platform by the single sign-on service, to complete resource extension for the zone of the cloud service platform.

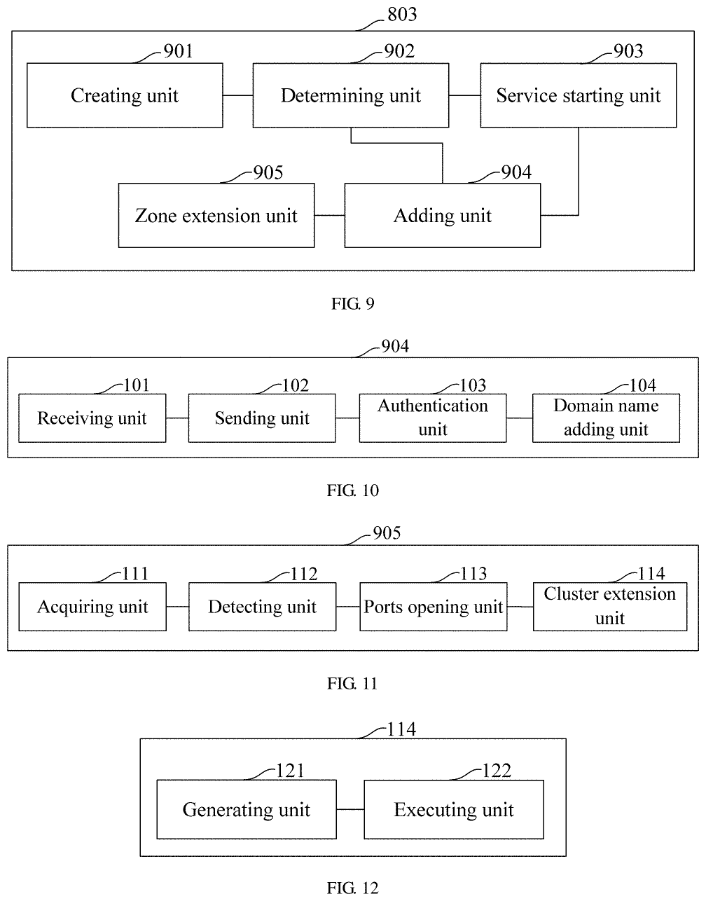

Specifically, as shown in FIG. 9, the extension unit 803 comprises a creating unit 901, a determining unit 902, a service starting unit 903, an adding unit 904, and a zone extension unit 905.

The creating unit 901 is used for creating a second virtual environment management platform. The determining unit 902 is used for determining whether the single sign-on service is started. The service starting unit 903 is used for starting the single sign-on service if the single sign-on service is not started. The adding unit 904 is used for adding a domain name and an IP address of the second virtual environment management platform by the single sign-on service if the single sign-on service is started. The zone extension unit 905 is used for adding the cluster of the second virtual environment management platform to the clusters of the zone, if an instruction of adding the resource in the second virtual environment management to the zone of the cloud service platform is received.

Specifically, as shown in FIG. 10, the adding unit 904 comprises a receiving unit 101, a sending unit 102, an authentication unit 103, and a domain name adding unit 104. The receiving unit 101 is used for receiving an input domain name and IP address of the second virtual environment management platform, and a username and a password of the single sign-on service. The sending unit 102 is used for sending an authentication request of the second virtual environment management platform to the single sign-on service, and the authentication request comprises a domain name and an IP address of the second virtual environment management platform, and a username and a password of the single sign-on service. The authentication unit 103 is used for completing mutual authentication between the single sign-on service and the second virtual environment management platform by the single sign-on service. The domain name adding unit 104 is used for adding the domain name and the IP address of the second virtual environment management platform to the single sign-on service.

Specifically, as shown in FIG. 11, the zone extension unit 905 comprises an acquiring unit 111, a detecting unit 112, a ports opening unit 113, and a cluster extension unit 114. The acquiring unit 111 is used for acquiring a selected cluster of the second virtual environment management platform that needs to be added, if an instruction of adding the resource in the second virtual environment management to the zone of the cloud service platform is received. The detecting unit 112 is used for detecting whether hosts in the selected cluster are available. The ports opening unit 113 is used for opening ports corresponding to firewalls in the hosts to implement communication with the cloud service platform, if the hosts in the selected cluster are available. The cluster extension unit 114 is used for adding the selected cluster to a cluster database of the zone of the cloud service platform. Specifically, as shown in FIG. 12, the cluster extension unit 114 comprises a generating unit 121 and an executing unit 122. The generating unit 121 is used for generating a SQL statement according to information of the hosts in the selected cluster. The executing unit 122 is used for executing the SQL statement in the cloud service platform to add the hosts in the selected cluster to the cluster database of the zone of the cloud service platform.

In other embodiments, the zone extension unit further comprises a modifying unit. The modifying unit is used for modifying the name of the hosts in the newly added cluster according to a preset rule.

For the specific working process of the above described device and unit, reference may be made to the corresponding process in the foregoing embodiments of the method, and the beneficial effects achieved may also be referred to the beneficial effects achieved in the foregoing embodiments of the method, and details are not described herein again.

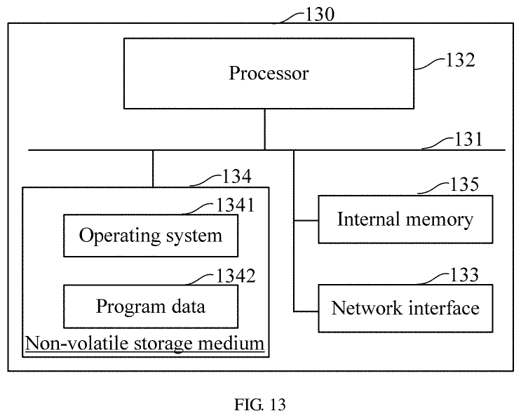

FIG. 13 is a schematic block diagram of a resource extension apparatus for a zone of a cloud service platform provided by an embodiment of the present disclosure. The apparatus 130 could be a terminal, such as a server and the like. The apparatus 130 comprises a processor 132, a memory, and a network interface 133 that are coupled by a system bus 131, wherein, the memory may comprise a non-volatile storage medium 134 and an internal memory 135.

The non-volatile storage medium 134 could store an operating system 1341 and program data 1342. When the program data 1342 is executed, the processor 132 could be caused to perform a resource extension method for a zone of a cloud service platform.

The processor 132 is used to provide computing and control capabilities, to support the operation of the entire device 130.

The internal memory 135 provides environment for the operation of the program data 1342 stored in the non-volatile storage medium 134, and when the program data is executed by the processor 132, the processor 132 could be caused to perform a resource extension method for a zone of a cloud service platform.

The network interface 133 is used for network communication, such as receiving instructions and the like. A person skilled in the art could understand that, the structure shown in FIG. 13 is only a block diagram of a part of the structure related to the solution of the present disclosure, and does not constitute a limitation to the apparatus 130 to which the solution of the present disclosure is applied. The specific apparatus 130 may comprise more or less components than those shown in the figure, or combine some components, or have a different arrangement for the components.

Wherein, the processor 132 is used for performing program data stored in the memory, to implement the following steps:

Pre-processing a cloud service platform; verifying a first virtual environment management platform in a zone of the cloud service platform by a single sign-on service; adding a cluster in a second virtual environment management platform to the zone of the cloud service platform by the single sign-on service, to complete resource extension for the zone of the cloud service platform.

In an embodiment, when the processor 132 performs adding a cluster in a second virtual environment management platform to the zone of the cloud service platform by the single sign-on service, the processor 132 specifically performs the following steps:

Creating the second virtual environment management platform; determining whether the single sign-on service is started; adding a domain name and an IP address of the second virtual environment management platform by the single sign-on service if the single sign-on service is started; adding the cluster of the second virtual environment management platform to the clusters of the zone, if an instruction of adding the resource in the second virtual environment management to the zone of the cloud service platform is received.

In an embodiment, when the processor 132 performs adding the cluster of the second virtual environment management platform to the clusters of the zone, the processor 132 specifically performs the following steps:

Acquiring a selected cluster of the second virtual environment management platform that needs to be added; detecting whether hosts in the selected cluster are available; opening ports corresponding to firewalls in the hosts to implement communication with the cloud service platform, if the hosts in the selected cluster are available; adding the cluster to a cluster database of the zone of the cloud service platform.

In an embodiment, when the processor 132 performs adding the cluster to a cluster database of the zone of the cloud service platform, the processor 132 specifically performs the following steps:

Generating a SQL statement according to information of the hosts in the cluster; executing the SQL statement in the cloud service platform to add the hosts in the cluster to the cluster database of the zone of the cloud service platform.

In an embodiment, when the processor 132 performs adding a domain name and an IP address of the second virtual environment management platform by the single sign-on service, the processor 132 specifically performs the following steps:

Receiving an input domain name and IP address of the second virtual environment management platform, and a username and a password of the single sign-on service; sending an authentication request of the second virtual environment management platform to the single sign-on service, and the authentication request comprises the domain name and the IP address, and the username and the password of the single sign-on service; completing mutual authentication between the single sign-on service and the second virtual environment management platform by the single sign-on service; adding the domain name and the IP address to the single sign-on service.

The present disclosure also provides a computer-readable storage medium, and the computer-readable storage medium stores one or more program data, and the one or more program data could be executed by one or more processors to implement the following steps:

Pre-processing a cloud service platform; verifying a first virtual environment management platform in a zone of the cloud service platform by a single sign-on service; adding a cluster in a second virtual environment management platform to the zone of the cloud service platform by the single sign-on service, to complete resource extension for the zone of the cloud service platform.

In an embodiment, when the program data is executed by the processor to add the cluster in the second virtual environment management platform to the zone of the cloud service platform by the single sign-on service, the specific implementation is:

Creating the second virtual environment management platform; determining whether the single sign-on service is started; adding a domain name and an IP address of the second virtual environment management platform by the single sign-on service if the single sign-on service is started; adding the cluster of the second virtual environment management platform to the clusters of the zone, if an instruction of adding the resource in the second virtual environment management to the zone of the cloud service platform is received.

In an embodiment, when the program data is executed by the processor to add the cluster of the second virtual environment management platform to the clusters of the zone, the specific implementation is:

Acquiring a selected cluster of the second virtual environment management platform that needs to be added; detecting whether hosts in the selected cluster are available; opening ports corresponding to firewalls in the hosts to implement communication with the cloud service platform, if the hosts in the selected cluster are available; adding the cluster to a cluster database of the zone of the cloud service platform.

In an embodiment, when the program data is executed by the processor to add the cluster to a cluster database in the zone of the cloud service platform, the specific implementation is:

Generating a SQL statement according to information of the hosts in the cluster; executing the SQL statement in the cloud service platform to add the hosts in the cluster to the cluster database of the zone of the cloud service platform.

In an embodiment, when the program data is executed by the processor to add the domain name and the IP address of the second virtual environment management platform by the single sign-on service, the specific implementation is:

Receiving an input domain name and IP address of the second virtual environment management platform, and a username and a password of the single sign-on service; sending an authentication request of the second virtual environment management platform to the single sign-on service, and the authentication request comprises the domain name and the IP address, and the username and the password of the single sign-on service; completing mutual authentication between the single sign-on service and the second virtual environment management platform by the single sign-on service; adding the domain name and the IP address to the single sign-on service.

A person skilled in the art could clearly understand that, for the convenience and brevity of the description, the specific working process of the device, the apparatus and the unit described above could refer to the corresponding process in the foregoing embodiments of the method, and details are not described herein again. The above description is only the specific embodiment of the present disclosure, but the scope of the present disclosure is not limited thereto, and any person skilled in the art could easily conceive various equivalent modifications and alternatives within the technical scope disclosed by the present disclosure, and these modifications or alternatives should all fall into the protection scope of the present disclosure.

1. A resource extension method for a zone of a cloud service platform, comprising:
pre-processing a cloud service platform;
verifying a first virtual environment management platform in a zone of the cloud service platform by a single sign-on service;
adding a cluster in a second virtual environment management platform to the zone of the cloud service platform by the single sign-on service, to complete resource extension for the zone of the cloud service platform.

2. The method according to claim 1, wherein the step of adding a cluster in a second virtual environment management platform to the zone of the cloud service platform by the single sign-on service comprises:
creating a second virtual environment management platform;
determining whether the single sign-on service is started;
adding a domain name and an IP address of the second virtual environment management platform by the single sign-on service, if the single sign-on service is started;
adding the cluster of the second virtual environment management platform to the clusters of the zone, if an instruction of adding the resource in the second virtual environment management to the zone of the cloud service platform is received.

3. The method according to claim 2, wherein the step of adding the cluster of the second virtual environment management platform to the clusters of the zone comprises:
acquiring a selected cluster of the second virtual environment management platform that needs to be added;
detecting whether hosts in the cluster are available;
opening ports corresponding to firewalls in the hosts to implement communication with the cloud service platform, if the hosts in the selected cluster are available;
adding the cluster to a cluster database of the zone of the cloud service platform.

4. The method according to claim 3, wherein the step of adding the cluster to a cluster database of the zone of the cloud service platform comprises:
generating a SQL statement according to information of the hosts in the cluster;
executing the SQL statement in the cloud service platform to add the hosts in the cluster to the cluster database of the zone of the cloud service platform.

5. The method according to claim 2, wherein the step of adding a domain name and an IP address of the second virtual environment management platform by the single sign-on service comprises:
receiving an input domain name and IP address of the second virtual environment management platform, and a username and a password of the single sign-on service;
sending an authentication request of the second virtual environment management platform to the single sign-on service, and the authentication request comprises the domain name and the IP address, and the username and the password of the single sign-on service;
completing mutual authentication between the single sign-on service and the second virtual environment management platform by the single sign-on service;
adding the domain name and the IP address to the single sign-on service.

6. (canceled)

7. (canceled)

8. (canceled)

9. (canceled)

10. (canceled)

11. An apparatus, comprising: a memory, and a processor connected to the memory;
the memory is used for storing program data for implementing resource extension for a zone of a cloud service platform; the processor is used for running the program data stored in the memory, to perform the following steps:
pre-processing a cloud service platform;
verifying a first virtual environment management platform in a zone of the cloud service platform by a single sign-on service;
adding a cluster in a second virtual environment management platform to the zone of the cloud service platform by the single sign-on service, to complete resource extension for the zone of the cloud service platform.

12. The apparatus according to claim 11, wherein, the processor further performs the following steps:
creating a second virtual environment management platform;
determining whether the single sign-on service is started;
adding a domain name and an IP address of the second virtual environment management platform by the single sign-on service, if the single sign-on service is started;
adding the cluster of the second virtual environment management platform to the clusters of the zone, if an instruction of adding the resource in the second virtual environment management to the zone of the cloud service platform is received.

13. The apparatus according to claim 12, wherein, the processor further performs the following steps:
acquiring a selected cluster of the second virtual environment management platform that needs to be added;
detecting whether hosts in the cluster are available;
opening ports corresponding to firewalls in the hosts to implement communication with the cloud service platform, if the hosts in the selected cluster are available;
adding the cluster to a cluster database of the zone of the cloud service platform.

14. The apparatus according to claim 13, wherein, the processor further performs the following steps:
generating a SQL statement according to information of the hosts in the cluster;
executing the SQL statement in the cloud service platform to add the hosts in the cluster to the cluster database of the zone of the cloud service platform.

15. The apparatus according to claim 12, wherein, the processor further performs the following steps:
receiving an input domain name and IP address of the second virtual environment management platform, and a username and a password of the single sign-on service;
sending an authentication request of the second virtual environment management platform to the single sign-on service, and the authentication request comprises the domain name and the IP address, and the username and the password of the single sign-on service;
completing mutual authentication between the single sign-on service and the second virtual environment management platform by the single sign-on service;
adding the domain name and the IP address to the single sign-on service.

16. A computer-readable storage medium, storing one or more program data which could be executed by one or more processors, to implement the following steps:
pre-processing a cloud service platform;
verifying a first virtual environment management platform in a zone of the cloud service platform by a single sign-on service;
adding a cluster in a second virtual environment management platform to the zone of the cloud service platform by the single sign-on service, to complete resource extension for the zone of the cloud service platform.

17. The computer-readable storage medium according to claim 16, wherein the steps further comprise:
creating a second virtual environment management platform;
determining whether the single sign-on service is started;
adding a domain name and an IP address of the second virtual environment management platform by the single sign-on service, if the single sign-on service is started;
adding the cluster of the second virtual environment management platform to the clusters of the zone, if an instruction of adding the resource in the second virtual environment management to the zone of the cloud service platform is received.

18. The computer-readable storage medium according to claim 17, wherein the steps further comprise:
acquiring a selected cluster of the second virtual environment management platform that needs to be added;
detecting whether hosts in the cluster are available;
opening ports corresponding to firewalls in the hosts to implement communication with the cloud service platform, if the hosts in the selected cluster are available;
adding the cluster to a cluster database of the zone of the cloud service platform.

19. The computer-readable storage medium according to claim 18, wherein the steps further comprise:
generating a SQL statement according to information of the hosts in the cluster;
executing the SQL statement in the cloud service platform to add the hosts in the cluster to the cluster database of the zone of the cloud service platform.

20. The computer-readable storage medium according to claim 17, wherein the steps further comprise:
receiving an input domain name and IP address of the second virtual environment management platform, and a username and a password of the single sign-on service;
sending an authentication request of the second virtual environment management platform to the single sign-on service, and the authentication request comprises the domain name and the IP address, and the username and the password of the single sign-on service;
completing mutual authentication between the single sign-on service and the second virtual environment management platform by the single sign-on service;
adding the domain name and the IP address to the single sign-on service.
